(19) United States
(12) Patent Application Publication
(10) Pub. No.: US 2026/0053707 A1
(43) Pub. Date: Feb. 26, 2026

(54) CENTRIFUGAL MEDICINE MIXER DEVICE AND RELATED METHODS

(71) Applicant: Jose Cascales, Brocatin, FL (US)

(72) Inventor: Jose Cascales, Brocatin, FL (US)

(21) Appl. No.: 18/810,555

(22) Filed: Aug. 21, 2024

(51) Int. Cl. A61J 1/20

(52) U.S. Cl. CPC A61J 1/2089

(57) ABSTRACT

A centrifugal medicine mixer device and method of mixing that includes a motor configured to have a shaft outwardly extending and rotatable about a longitudinal axis. The shaft is rigidly attached to a bracket, the bracket having the ability to rotate about a longitudinal axis with the shaft. The bracket is attached to a first container and a counterpart second container, respectively. The first container and counterpart second container contain one or more medicines and one or more counterpart aqueous solutions, whereby medicines and counterpart second aqueous solutions are adjacent and fluidly connected. The longitudinal axis in which the bracket rotates, by operation of the motor, creates centrifugal action about the rotating longitudinal axis. The centrifugal force allows a portion of each of the counterpart aqueous solutions to flow, via the fluid connection, into the one or more first containers and mix with the one or more medicines.

### TECHNICAL FIELD

The present invention relates to the field of medical devices, and, more specifically, devices that mix, reconstitute, or prepare medicinal substances. The invention further relates to a method of mixing, reconstituting, or preparing said medicinal substances.

### BACKGROUND OF THE INVENTION

Over the last several decades, the home infusion pharmacy industry has helped to achieve better health outcomes at a lower cost as compared to hospital-based institutions, physician offices, and clinics. Home infusion pharmacies permit medical patients to receive necessary medicines via intravenous infusion in the patient's home with the use of an infusion pump, rather than receiving the infusion at an infusion center, physician office, or at a hospital.

Most medicines, especially medicines administered via intravenous infusion either in a hospital or home setting, are manufactured as sterile lyophilized powders. This method of manufacture permits these medicines to be stored at room temperature for long periods of time. However, intravenous medicines in lyophilized powder form must be reconstituted and compounded into an aqueous solution so that the medicines can be available for delivery to a patient, for example, via an intravenous infusion.

Medicines that require mixing or reconstitution, e.g., medicine comprised of lyophilized powders and medicines comprised of aqueous solutions, are often kept separately in two different vials. The primary benefit of separating the components is to increase shelf life, as these products are often unstable after a short period of time post-reconstitution. Mixing and reconstituting of medicines typically requires a patient or nurse to manually connect two or more medicine containers via a conduit, and manually shake or tilt the containers by hand whereby slowly mixing the two or more medicines. This manual mixing process allows for errors in mixing including incomplete mixing of lyophilized powders and clumping of medicine substances.

The need to reconstitute and compound the lyophilized powder in a clean room, the time-consuming process of fully preparing the mixed medicine, and the maintenance in refrigerating the reconstituted medicines all add to the cost of patient self-administered intravenous home medication infusions. Existing medicinal mixing and reconstituting devices are limited in the window of preparation time that they provide, requiring the patient or a nurse to mix or reconstitute the medicines just prior to the time of use. Such preparation times are inconvenient for scheduling and time management. These limitations add to the overall cost for the patient, as the patient must provide a clean environment and spend preparation time for each and every instances of use.

The process of preparing the reconstituted medicines also increases waste. Wastes generated from a conventional reconstitution includes a vial, a vial adaptor, a syringe, time wasted during product preparation, and any reconstituted products that have lost their efficacies. The opportunity cost of conventional reconstitutions varies depending on which healthcare professionals are preparing the products; nevertheless, the time and attention needed to prepare the reconstituted products can be invested in other parts of the workflow to prepare an injectable material. Existing medicinal mixing and reconstituting devices on the market require that the patient utilize mixing containers or syringes in addition to the syringes, medication bottles, and containers already shipped or distributed to the patient with the allotted medication kits, creating redundancy and increase in waste.

Although significant progress has been made in recent years with respect to medicinal mixing and reconstituting devices and methods, there still exists a need for a more efficient and streamlined all-encompassing apparatus to permit the sterile mixing and/or reconstitution and compounding of intravenous injection medicines by the patient, nurse, or other lay person. Thus, the present invention provides a medicine mixing and reconstituting system and methods of manufacture which overcome the disadvantages of prior art medicinal mixing and reconstituting devices.

### SUMMARY OF THE INVENTION

The present invention provides for a centrifugal medicine mixer device and method mixing, comprising a motor configured to have a shaft which outwardly extends and is rotatable about a longitudinal axis. The shaft is rigidly attached to a bracket, the bracket having the ability to rotate about a longitudinal axis in an axial direction with the shaft. In this embodiment, the bracket is rigidly attached to a plurality of holders. Each holder can securely hold a first container and a counterpart second container, respectively. the bracket comprises a plurality of holders for securely holding the one or more vials and the one or more syringes adjacent and in axially alignment with each other.

In some embodiments, the motor is a variable speed electric motor, and further comprises a controller for controlling the rotational speed and direction of the shaft. In other embodiments, the motor may be rigidly attached to a base member, said base member may further be comprised of a container for storing one or more medicines. Embodiments may also comprise a refrigerated container for storing for a longer period prior to use.

Each first container may contain one or more medicines, and each counterpart second container may contain one or more counterpart aqueous solutions. Each first container and each counterpart second container are configured to connect to each other, one first container to one counterpart second container respectively, via a conduit. When the first container and the counterpart second container are connected with the conduit, the one or more medicines and the one or more counterpart aqueous solutions form a fluid connection. The longitudinal axis in which the bracket and holders rotate, by operation of the motor, creates centrifugal action about the rotating longitudinal axis in an axial direction. The centrifugal force allows a portion of each of the one or more counterpart aqueous solutions to flow, via the fluid connection, into the one or more first containers and mix with the one or more medicines.

In some embodiments, the centrifugal medicine mixer device further includes a housing that protects and encloses the bracket. The housing is comprised of a housing door that provides access to the bracket. In some embodiments, the housing is constructed from an opaque material capable of filtering Ultraviolet A (UVA) and Ultraviolet B (UVB) light. This allows the centrifugal medicine mixer device to mix one or more medicines without adverse effects due to exposure of the medicines to direct sunlight.

These and other aspects of the present invention will become more readily apparent to those of ordinary skill in the art when reference is made to the following detailed description in conjunction with the accompanying drawings.

### BRIEF DESCRIPTION OF DRAWINGS

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not considered as limiting of the scope of the invention or the claims herein in any way.

FIG. 1 is a configuration of an example centrifugal medicine mixer device, according to some embodiments.

FIG. 2 is an exploded perspective view of the centrifugal medicine mixer device of FIG. 1, according to some embodiments.

FIG. 3 is a side perspective view of the centrifugal medicine mixer device of FIG. 1, according to some embodiments.

FIG. 4 is a front perspective view of the centrifugal medicine mixer device, opposite side of FIG. 1, according to some embodiments.

FIG. 5 shows the process of connecting a first container to a counterpart second container via a conduit, according to some embodiments.

FIG. 6 is plan view in which one of a plurality of holders is attached to the bracket and securely holding a first containers and a counterpart second container, according to some embodiments.

FIG. 7 is a schematic front view of the centrifugal medicine mixer device of FIG. 1, showing the upright rotational point of the bracket, first containers, and counterpart second containers, according to some embodiments.

FIG. 8 is a schematic front view of the centrifugal medicine mixer device of FIG. 1, showing the 180 degree rotational halfway point of a complete 360 degree rotation of the bracket, first containers, and counterpart second containers, according to some embodiments.

FIG. 9 is flowchart showing a method for mixing medicines via centrifugal force, according to some embodiments.

FIG. 10 is flowchart showing a method for mixing medicines via centrifugal force, according to some embodiments that comprise a housing that protects and encloses the bracket.

### DETAILED DESCRIPTION OF THE INVENTION

In the following detailed description, reference is made to the accompanying drawings, which form a part hereof. In the drawings, similar symbols or markings have been used to identify like or corresponding parts or elements, unless context dictates otherwise. The illustrative embodiments described and illustrated in the detailed description and drawings are not meant to be limiting and are not necessarily to scale. Rather, other embodiments may be utilized, and other changes may be made, without departing from the scope of the invention as defined by the appended claims.

Headings and sections provided in this disclosure, including the title of this patent application, are for convenience only and are not to be taken as limiting this disclosure in any way.

Distinguishing terms including “first”, “second”, “third”, etc. may be used herein to describe various elements, components, regions, layers, or sections, and should not be limited by these terms. The terms “first”, “second”, “third”, etc. and other numerical terms, when used herein, do not imply a sequence or order unless clearly indicated by the context of this disclosure, and are only used to distinguish one element, component, region, layer, or section from other elements, components, regions, layers, or sections.

The use of “including,” “comprising,” or “having” and variations thereof herein is meant to encompass the items listed thereafter and equivalents thereof as well as additional items. Unless specified or limited otherwise, the terms “affixed,” “associated,” “attached,” “connected,” “coupled” and “supported,” and variations thereof are used broadly and encompass both direct and indirect connections, supports, and couplings. It is to be understood that other embodiments may be utilized, and structural or logical changes may be made without departing from the scope of the present disclosure.

Terms such as “front,” “rear,” “top,” “bottom,” “left,” “right,” and the like are only used to describe elements as they relate to one another but are in no way meant to recite specific orientations of the apparatus, to indicate or imply necessary or required orientations of the apparatus, or to specify how the invention described herein will be used, mounted, displayed, or positioned in use.

In the context of the present invention, the term “container” used herein is meant in its broadest sense and includes, without limitation, syringes, tubes, vials, ampoules, bottles, cartons, blister packs, sachets, or any other vessel intended to hold one or more medicines. This list is not intended to be exhaustive or distinguish between types of containers or parts of containers that differ in name but not function.

In the context of the present invention, the term “conduit” used herein is meant in its broadest sense and includes, without limitation, vial access spikes, luer locks, vial adaptor, syringe adaptor, stopcock, needle, tube, port, or any other passageway that connects a container to another container. This list is not intended to be exhaustive or distinguish between types of medical tools or parts of medical tools that differ in name but not function.

In view of the foregoing and the accompanying drawings, the present invention is directed to in an example embodiment, a device for and methods of mixing one or more medicines.

Referring now to the drawings, FIGS. 1 and 2 are configuration and exploded view, respectively, of an example centrifugal medicine mixer device 100 according to some embodiments of the invention. FIGS. 3 and 4 is a side perspective views and front perspective views of the centrifugal medicine mixer device 100, respectively.

As shown in FIGS. 1, 2, and 4, the device 100 includes a motor 102, which is configured to have a shaft 104 which outwardly extends and is rotatable about a longitudinal axis. The shaft 104 is rigidly attached to a bracket 106, the bracket 106 having the ability to rotate about a longitudinal axis with the shaft 104. In this embodiment, the bracket 106 is rigidly attached to a plurality of holders 108. Each holder 108 can securely hold a first container 110 and a counterpart second container 114, respectively.

Each first container 110 as shown in FIGS. 1, 2, and 4 may contain one or more medicines 112, and each counterpart second container 114 may contain one or more counterpart aqueous solutions 116. Each first container 110 and each counterpart second container 114 are configured to connect to each other, one first container 110 to one counterpart second container 114 respectively, via a conduit 118. When the first container 110 and the counterpart second container 114 are connected with the conduit 118, the one or more medicines 112 and the one or more counterpart aqueous solutions 116 form a fluid connection.

As shown in FIGS. 1, 2, and 4, the device 100 in some embodiments further includes a housing 120 that protects and encloses the bracket 106. The housing 120 is comprised of a housing door 122 that provides access to the bracket 106. In some embodiments, the housing 120 is constructed from an opaque material capable of filtering Ultraviolet A (UVA) and Ultraviolet B (UVB) light. This allows the centrifugal medicine mixer device 100 to mix one or more medicines 112 without adverse effects due to exposure of the medicines 112 to direct sunlight.

As shown in FIG. 4, the bracket 106 comprises a plurality of holders 108 for securely holding the one or more vials and the one or more syringes adjacent and in axially alignment with each other. In some embodiments, the first container 110 or the counterpart second container 114 may include, without limitation, syringes, tubes, vials, ampoules, bottles, cartons, blister packs, sachets, or any other vessel intended to hold one or more medicines 112.

FIG. 3 is a side perspective view of the centrifugal medicine mixer device 100, according to some embodiments. In the present embodiment, the motor 102 is a variable speed electric motor 102, and further comprising a controller 124 for controlling the rotational speed and direction of the shaft 104. The controller 124 may be rigidly attached to the motor 102 in some embodiments. In other embodiments, the controller 124 may be operated remotely. Variations may include the controller 124 comprising a handheld remote device.

In some embodiments, the controller 124 may rotate the syringe and vials at a relatively slow speed wherein a lower centrifugal force is created. Slow and prolonged centrifugal mixing and reconstituting operations help to avoid the generation of air bubbles during the mixing process. Avoiding air bubbles allows for more control over medicine efficacy, eliminating further aggregation and denaturation of ingredients, especially in active ingredients that may deteriorate at faster rates.

As shown in FIG. 3, the present embodiment comprises a motor 102 that is rigidly attached to a base member 126. Other embodiments may comprise a device without a base member 126. In some embodiments, and in the present embodiment, the base member 126 may further be comprised of a container 128, able to store one or more first containers 110 and one or more counterpart second containers 114. In some embodiments, including the embodiment shown in FIG. 3, the base member may comprise a refrigerated container 128. The refrigerated container 128 provides one or more medicines 112, first containers 110, counterpart aqueous solutions 116, counterpart second containers 114, or mixed medicines to be stored for a longer period prior to use. In the embodiment shown in FIG. 3, the refrigerator container 128 is configured to include a refrigerator container door 130 that provides access to stored medicines 112, first containers 110, counterpart aqueous solutions 116, counterpart second containers 114, or mixed medicines.

FIG. 5 shows the process of connecting a first container 110 to a counterpart second container 114 via a conduit 118, according to some embodiments. FIG. 6 is a plan view where one of a plurality of holders 108 is attached to the bracket 106 and securely holding a first containers 110 and a counterpart second container 114. In some embodiments, one or more first containers 110 are vials, and one or more second containers a syringes. In the present embodiment, the vials and syringes are axially aligned and fluidly connection to each other by a conduit 118. In some embodiments, the conduit 118 may include, without limitation, vial access spikes, luer locks, vial adaptor, syringe adaptor, stopcock, needle, tube, port, or any other passageway that connects one container to another container. As shown in FIG. 5, and according to some embodiments, the conduit 118 may further comprise a valve 132, positioned along each conduit, for control of the flow of a combination of one or more medicines 112 or counterpart aqueous solutions 116 between the first container 110 and the counterpart second container 114 via the conduit 118.

FIGS. 7 and 8 are schematic front views of the centrifugal medicine mixer device 100, showing the rotational operation of the bracket 106, first containers 110, and counterpart second containers 114. FIG. 7 specifically shows the bracket 106, first containers 110 and counterpart second containers 114 in an upright rotational point. According to some embodiments, and in the present embodiment shown in FIG. 7, the bracket 106 and plurality of holders 108 are in an upright position, allowing for first containers 110 and counterpart second containers 114 to be attached to said holders 108 and held in perpendicular alignment to said holders 108. FIG. 8 specifically shows the bracket 106, first containers 110 and counterpart second containers 114 in a 180 degree rotational point, displaying the halfway point of a complete 360 degree rotation has occurred during operation of the motor 102. FIGS. 7 and 8 show the axial direction 134 along the longitudinal axis in an axial direction 134 in which the bracket 106 and holders 108 rotate, by operation of the motor 102, thereby creating centrifugal action about the rotating longitudinal axis. The centrifugal force allows a portion of each of the one or more counterpart aqueous solutions 116 to flow into the one or more first containers 110 and mix with the one or more medicines 112.

Methods for mixing medicines 112 by using the centrifugal medicine mixer device 100 will be described in detail as follows.

FIGS. 9 and 10 show flowcharts showing the method for mixing one or more medicines 112 according to some embodiments. FIG. 9 is a flowchart showing the method of mixing one or more medicines 112 with an embodiment of the centrifugal medicine mixer device 100 that does not comprise a housing 120.FIG. 10 is a flowchart that shows the method of mixing medicines 112 when the device includes a housing 120 that encloses the bracket 106. Variations in embodiments described in FIG. 9 apply to FIG. 10 unless otherwise specified.

The method for mixing one or more medicines 112 according to FIG. 9,performs steps S1-S6 by using the centrifugal medicine mixer device 100,according to some embodiments and shown in FIG. 4. The first step of providing and using a motor 102 with an outwardly extending rotatable shaft 104 is shown in Step S1. The motor in step S1 can be, for example, a variable speed electric motor, and further comprising a controller 124 for controlling the rotational speed and direction of the shaft. Other embodiments further comprise a base member 126 rigidly attached to the motor 102. The base member 102 may, for example, comprise a container for storage of one or more first containers 110, one or more counterpart second containers 114, medicines 112, counterpart aqueous solutions 116, or mixed medicines. In some embodiments, the base member may comprise a refrigerated container 128. Step S2 is the step for providing and verifying one or more first containers 110 containing one or more medicines 112.The first containers can include, without limitation, syringes, tubes, vials, ampoules, bottles, cartons, blister packs, sachets, or any other vessel intended to hold one or more medicines 112. Step S3 is the step for providing and verifying one or more counterpart second containers 114 containing the one or more counterpart aqueous solutions 116. Step S4 is the step for fluidly connecting each of the one or more first containers 110 individually to one of the one or more counterpart second containers 114. This step may further include providing a conduit 118 which may include, without limitation, vial access spikes, luer locks, vial adaptor, syringe adaptor, stopcock, needle, tube, port, or any other passageway that connects one container to another container. The conduit 118 may further comprise a valve 132, as shown in FIG. 5, positioned along each conduit, for control of the flow of a combination of one or more medicines 112 or counterpart aqueous solutions 116 between the first container 110 and the counterpart second container 114 via the conduit 118. Steps S5B and S5D are performed sequentially and without steps S5A, S5C, and S5E, shown in the method for FIG. 10 only. Step S5B is the step for providing and rigidly attaching a bracket 106 to the shaft 104. Step S5D is the step for attaching bracket 106 to each of the one or more first containers 110 and each of the one or more counterpart second containers 114. The bracket may, according to some embodiments, further comprise a plurality of holders 108 for securely holding the one or more first containers 110 and counterpart second containers 114 adjacent and in axially alignment with each other. Finally, step S6 is the step for operating the motor 102 to create centrifugal action about the rotating longitudinal axis in an axial direction 134, which mixes one or more medicines 112 with one or more counterpart aqueous solutions 116 under centrifugal action. Steps S2-S4 and steps S5D-S6 may be repeated as needed for mixing multiple and subsequent medicines for large batch size.

FIG. 10, on the other hand, performs steps S1-S6 by using the centrifugal medicine mixer device 100 as seen in FIGS. 1 and 2 with the use of a housing 120 and housing door 122. Steps S1-S4 and S6 follow the same steps and order as the method shown in FIG. 9. Steps S5A, S5C, and S5E are performed when the centrifugal medicine mixer device 100 comprises a housing 120 and housing door 122. More specifically, the first step FIG. 10 is providing and using a motor 102 with an outwardly extending rotatable shaft 104 is shown in Step S1. Step S2 is the step for providing and verifying one or more first containers 110 containing one or more medicines 112. Step S3 is the step for providing and verifying one or more counterpart second containers 114 containing the one or more counterpart aqueous solutions 116. Step S4 is the step for fluidly connecting each of the one or more first containers 110 individually to one of the one or more counterpart second containers 114. Step S5A is the step for providing a housing 120 that encloses a bracket 106, and a housing door 122 that provides access to bracket 106. The housing 120 in step S5A can, for example, be constructed from an opaque material capable of filtering Ultraviolet A (UVA) and Ultraviolet B (UVB) light. This allows the centrifugal medicine mixer device 100 to mix one or more medicines 112 without adverse effects due to exposure of the medicines 112 to direct sunlight. Step S5B is the step for providing and rigidly attaching a bracket 106 to the shaft 104. Step S5C is the step for opening housing door 122 to access bracket 106 inside housing 120.Step S5D is the step for attaching bracket 106 to each of the one or more first containers 110 and each of the one or more counterpart second containers 114.Step S5E is the step for closing housing door 122 to secure the first containers 110 and the counterpart second containers 114 inside housing 120. Finally, step S6 is the step for operating the motor 102 to create centrifugal action about the rotating longitudinal axis in an axial direction 134, which mixes one or more medicines 112 with one or more counterpart aqueous solutions 116 under centrifugal action.

As an aid to a fuller understanding of the present invention and all of its features, the following reference character list identifies most all of the parts and features of the centrifugal medicine mixer device 100 described and illustrated herein.

### LIST OF DRAWING REFERENCE CHARACTERS

100—Centrifugal medicine mixer device
102—Motor
104—Shaft
106—Bracket
108—Holders
110—First container
112—Medicine
114—Counterpart second container
116—Counterpart aqueous solution
118—Conduit
120—Housing
122—Housing door
124—Controller
126—Base member
128—Refrigerated container
130—Refrigerated container door
132—Valve
134—Axial direction

The above descriptions are meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications, and such variations, modifications, and improvements thereof are made obvious by this disclosure and are intended to be part of this description though not expressly stated herein.

Devices disclosed in this application including techniques and mechanisms described or referenced herein will sometimes be described in singular form for clarity, however, embodiments may include multiple iterations of a technique or multiple instantiations of a mechanism unless noted otherwise. Diagrams and figures disclosed in the drawings should be understood as representing modules, segments, or portions. Alternate implementations are included within the scope of embodiments wherein functions may be executed out of order from that shown or discussed, including substantially concurrently or in reverse order, depending on the functionality involved, as would be understood by those having ordinary skill in the art.

While the present invention has been described in the context of the embodiments illustrated and described herein, the invention may be embodied in other specific ways or in other specific forms without departing from its scope or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

1. A centrifugal medicine mixer device for mixing one or more medicines with one or more counterpart aqueous solutions, comprising:
a motor having an outwardly extending shaft rotatable about a longitudinal axis;
one or more first containers containing the one or more medicines;
one or more counterpart second containers containing the one or more counterpart aqueous solutions, wherein each of the one or more first containers is adjacent, and fluidly connected to, one of the one or more counterpart second containers;
a bracket rigidly attached to the shaft, and attached to each of the one or more first containers and to each of the one or more counterpart second containers, whereby, and when the motor is operating thereby creating centrifugal action about the rotating longitudinal axis, a portion of each of the one or more counterpart aqueous solutions is able to flow, under centrifugal action, into the one or more first containers and mix with the one or more medicines.

2. The centrifugal medicine mixer device of claim 1 wherein the motor is a variable speed electric motor, and further comprising a controller for controlling the rotational speed and direction of the shaft.

3. The centrifugal medicine mixer device of claim 2 wherein the one or more first containers are vials, and wherein the one or more second containers a syringes, and wherein the vials and syringes are axially aligned and fluidly connection to each other by a conduit.

4. The centrifugal medicine mixer device of claim 3, further comprising a valve positioned along each conduit.

5. The centrifugal medicine mixer device of claim 4, further comprising a housing that protects and encloses the bracket.

6. The centrifugal medicine mixer device of claim 5, wherein said housing is constructed from an opaque material capable of filtering Ultraviolet A (UVA) and Ultraviolet B (UVB) light.

7. The centrifugal medicine mixer device of claim 3, wherein the bracket comprises a plurality of holders for securely holding the one or more vials and the one or more syringes adjacent and in axially alignment with each other.

8. The centrifugal medicine mixer device of claim 3, wherein the motor is rigidly attached to a base member.

9. The centrifugal medicine mixer device of claim 8, wherein said base member is further comprised of a refrigerated container, able to store one or more first containers and one or more counterpart second containers.

10. A method of mixing one or more medicines with one or more counterpart aqueous solutions, comprising the steps of:
providing and using a motor, wherein said motor comprises an outwardly extending shaft rotatable about a longitudinal axis;
providing and verifying one or more first containers, wherein first containers contain the one or more medicines;
providing and verifying one or more counterpart second containers, wherein said counter part containers containing the one or more counterpart aqueous solutions;
fluidly connecting each of the one or more first containers individually to one of the one or more counterpart second containers;
providing a bracket, and rigidly attaching said bracket to said shaft;
attaching said bracket to each of the one or more first containers and each of the one or more counterpart second containers;
operating said motor to create centrifugal action about the rotating longitudinal axis, whereby a portion of each of the one or more counterpart aqueous solutions flows, under centrifugal action, into the one or more first containers, mixing with the one or more medicines.

11. The method of claim 10, further comprising the step of providing a controller for controlling the rotational speed and direction of the shaft.

12. The method of claim 10, further comprising the step of axially aligning and fluidly connecting one or more first containers individually with one or more second containers individually by a conduit.

13. The method of claim 12, further comprising the step of providing a valve positioned along each conduit.

14. The method of claim 10, further comprising the step of providing a housing that protects and encloses the bracket.

15. The method of claim 10, wherein said housing is constructed from an opaque material capable of filtering Ultraviolet A (UVA) and Ultraviolet B (UVB) light.

16. The method of claim 10, wherein the bracket further comprises a plurality of holders for securely holding the one or more vials and the one or more syringes adjacent and in axially alignment with each other.

17. The method of claim 10, wherein the motor is rigidly attached to a base member.

18. The method of claim 10, wherein said base member is further comprised of a refrigerated container, able to store one or more first containers and one or more counterpart second containers.
